(19) United States
(12) Patent Application Publication
(10) Pub. No.: US 2008/0259364 A1
(43) Pub. Date: Oct. 23, 2008

(54) IMAGE FORMING APPARATUS

(76) Inventors: Shinji MORITA, Tokyo (JP); Tadayuki Ueda, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/868,285

(22) Filed: Oct. 5, 2007

(30) Foreign Application Priority Data
Nov. 29, 2006 (JP) JP2006-321671

(51) Int. Cl. G06F 15/00

(52) U.S. Cl. 358/1.9

(57) ABSTRACT

An image forming apparatus including a plurality of image forming sections arranged in tandem for forming an image having a plurality of colors, the image forming apparatus having: an image reading section for reading an image of a document; an exposure unit having each color exposure section for conducting each color exposure for writing the image, a process unit having a plurality of image forming sections for forming a toner image based on the image read by the image reading section; and a casing for accommodating the image reading section, the exposure unit and the process unit, wherein the exposure unit and the process unit are integrated as an image forming unit and the image forming unit is structured so that it can be drawn from the casing.

### RELATED APPLICATION

This application is based on Japanese Patent Application No. 2006-321671 filed on Nov. 29, 2006, in Japanese Patent Office, the entire content of which is hereby incorporated by reference.

### TECHNICAL FIELD

The present invention relates to an image forming apparatus, particularly, to a unit structure of the image forming apparatus.

### BACKGROUND

An image forming apparatus such as a copier or integral apparatus provided with a copy function, facsimile function, printer function, scanner function is spread in the market. This image forming apparatus is, as an example, structured by an automatic document feeder for feeding the document, an image forming apparatus main body for forming an image by a publicly known electronic photographing system, after processing apparatus for conducting an after processing such as shift processing, saddle stitch processing, half folding processing.

The image forming apparatus main body is structured by an image reading section for reading the image from the document, an image processing section for processing the read image, an image forming section for image forming on a sheet based on the image processed image data, a sheet accommodation section for accommodating the sheet, and a conveying section for conveying the sheet.

Further, the image forming section is, further, as an example, structured by a photoreceptor drum, and a charging section for charging the photoreceptor drum, an exposure section for writing an electrostatic latent image on the photoreceptor drum, a developing section for developing the electrostatic latent image and for forming a toner image, a transfer section for transferring the toner image after the toner image on the photoreceptor drum onto the intermediate transfer belt, for transferring onto the sheet through the secondary transfer roller, and a fixing section for fixing the transferred image.

When the operation of the above image forming apparatus is reviewed, the document placed on the platen of the automatic document feeder is successively fed to the image reading section, scanned the document by an optical system of the image reading section, and the document is read by a line image sensor CCD (Charge Coupled Device). A signal from the line image sensor CCD is, in the image processing section, after analog processing, A/D conversion, shading correction, image compression processing are conducted, sent to the image forming section. In the image forming section, each color of electrostatic latent image is formed by the exposure section on the photoreceptor drum charged by the charging section, after, by the developing section, made the toner image, and successively secondary transferred onto the intermediate transfer belt by the transfer section, and the superimposed color toner image is formed. Then, the sheet accommodated in the sheet accommodation section is fed by the conveying section, and through the sheet feed roller, register roller, conveyed to the transfer section, and the color toner image on the intermediate transfer belt is secondary transferred onto the sheet by the secondary transfer roller. The sheet onto which the color toner image is transferred is heated and pressed in the fixing section, and the color toner image on the sheet is fixed. After that, it is conveyed to the after-processing apparatus by the conveying section, or delivered.

In the image forming apparatus of the above structure, it is unitized so that the cleaning of each section, or replacement of parts constituting each section can be easily conducted, for example, the exposure section of the image forming section is structured as an exposure unit, the photoreceptor drum of the image forming section, charging section, developing section are structured as a process unit. In them, because in the process unit, the soil by the toner is easily generated, it is necessary that the access and cleaning can be easily conducted from the outside, and the apparatus in which in the case of the image forming apparatus provided with only a monochrome copy function, the upper section of the image forming apparatus is structured so that it is opened and closed, the upper section of the main body is released at the time of cleaning, and the process unit is exposed, is well known.

However, in the image forming apparatus provided with the color copy function, in the structure in which the image forming sections of each of colors of yellow (Y), magenta (M), cyan (C), black (K) are arranged in tandem, generally, the exposure unit is arranged in the upper section of the process unit, a toner hopper (toner supply section) for holding the toner for supplying the toner to each process unit is arranged, further, in the case of the apparatus provided with a scanner function, because the scanner section is arranged above the process unit, when the structure in which the upper section of the main body is opened and closed, is adopted, it is necessary that the exposure unit, toner hopper, scanner are opened together. Therefore, the weight of the open-close section is increased, it can not be opened and closed simply, and a problem that the vibration or impact is given to the image forming apparatus at the time of open and close, in the interval between units (for example, the interval between the exposure section and the photoreceptor), misalignment is generated and the quality of print is lowered, is generated.

Accordingly, in the image forming apparatus in which each image forming section is arranged in tandem horizontally, the structure for drawing out the process unit horizontally is adopted. For example, in Japanese Unexamined Paten Application Publication No. 2005-156619, as shown in FIG. 8, in the tandem system image forming apparatus 100 provided with the photoreceptor or developing unit for each color, the image carrier unit and the developing unit is equipped in the developing casing 120, the developing casing 120 or the transfer unit is equipped in the main body casing 110, and for the image carrier unit, the structure in which it is detachably equipped in the developing casing 120, the developing casing is equipped so that it can be drawn out and inserted, in the main body casing 110, is disclosed.

However, when LED (light emitting diode) is used as the light source of the exposure section, because the exposure unit and the process unit are arranged in proximity, when the process unit is drawn out in the horizontal direction, the process unit interferes with the exposure unit. Accordingly, the structure is necessary in which after the process unit and the exposure unit are separated at a time, the process unit is drawn out. Therefore, the structure of the image forming apparatus becomes complicate and cost is increased, the space for retreating the exposure unit is necessary, also resulting in the increase of the size. Further, because the exposure unit and the process unit are completely separated, the position accuracy between both units can not be kept.

Further, because the glass plate for protecting the light source of the exposure unit is soiled by the toner, it is necessary to clean it, however, in the structure for drawing out only the process unit (that is, the structure for remaining exposure unit in the image forming apparatus main body side), the cleaning is difficult, and a special tool is necessary for the cleaning operation or a problem that the skill is necessary for the cleaning operation, is generated

In view of the above problems, the present invention is attained, and the main object of the present invention is to provide an image forming apparatus which can easily maintain and inspect the exposure unit and the process unit, while the increase of the cost or size is suppressed at maximum, the position accuracy between units, particularly, the exposure unit and the process unit is secured.

### SUMMARY OF THE INVENTION

According to one aspect of the invention, an image forming apparatus including a plurality of image forming sections arranged in tandem for forming an image having a plurality of colors is provided, the image forming apparatus comprising: an image reading section for reading an image of a document; an exposure unit having each color exposure section for conducting each color exposure for writing the image, a process unit having a plurality of image forming sections for forming a toner image based on the image read by the image reading section; and a casing for accommodating the image reading section, the exposure unit and the process unit,

wherein the exposure unit and the process unit are integrated as an image forming unit and the image forming unit is structured so that it can be drawn from the casing.

As described above, the present invention can suppress the increase of the cost by simplifying the structure, the retreat space of the exposure unit when the unit is drawn from the casing, is not necessary and the increase of the size is suppressed, and by not separating the exposure unit and the process unit, the position accuracy of them is maintained, and the maintenance of the exposure unit and the process unit can be made easy.

According to the image forming apparatus of the present invention, the effects written in following can be attained.

Because the exposure unit and the process unit are made the structure in which they are integrally drawn out, the structure of the image forming apparatus can be simplified and when they are drawn out, it is not necessary that the space for retreating the exposure unit is provided in the image forming apparatus, and the increase of the cost or size can be suppressed.

Further, because it is not the structure in which only the process unit is drawn out and the exposure unit is remained in the image forming apparatus main body, but the structure in which the exposure unit and the process unit can be integrally drawn out, the misalignment of the position between units, does not generate, the position accuracy between the exposure unit and the process unit can be maintained.

Further, because after the exposure unit and the process unit are integrally drawn out, the exposure unit can be opened by the hinge part, the access can be made easily to both the exposure unit and the process unit, the maintenance of the exposure unit and the process unit can be easily conducted.

### BRIEF DESCRIPTION OF THE DRAWINGS

FIG. 1 is a view showing the inside structure of the image forming apparatus main body according to the present invention.

FIG. 2 is a view in which a part of the image forming section of the image forming apparatus main body according to the present invention is enlarged.

FIG. 3 is a perspective view showing the structural example of the integrated unit including the exposure unit and the process unit according to the present invention.

FIG. 4 is a perspective view showing the structure of the casing of the image forming apparatus main body according to the present invention.

FIG. 5 is a perspective view showing the situation in which the image forming unit is assembled in the casing of the image forming apparatus main body according to the present invention.

FIG. 6 is an enlarged view of the hinge part side in the situation in which the image forming unit is loaded into the casing of the image forming apparatus main body according to the present invention.

FIG. 7 is an enlarged view of the opposite side to the hinge part in the situation in which the image forming unit is loaded into the casing of the image forming apparatus main body according to the present invention.

FIG. 8 is a perspective view showing the structure of the conventional image forming apparatus.

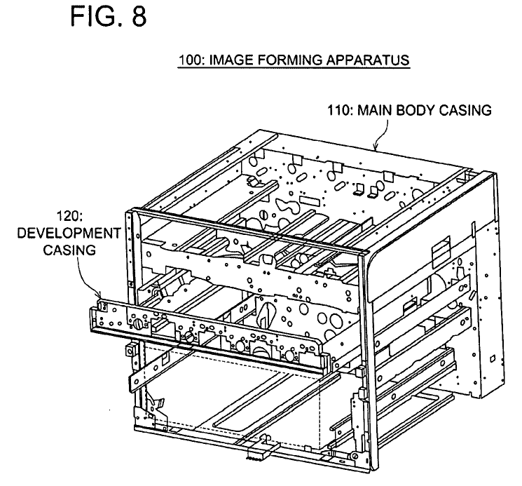

### DESCRIPTION OF THE PREFERRED EMBODIMENTS

As described in the prior art, in the image forming apparatus in which each color of the image forming section is arranged horizontally in tandem, because only the process unit including the photoreceptor, charging section, developing section is drawn out, the structure in which the exposure unit including the exposure section is remained in the image forming apparatus main body side, is adopted, when the process unit is drawn out, the mechanism for retreating the exposure unit so that the process unit does not interfere with the exposure unit, is necessary. Therefore, there are problems that the structure of the image forming apparatus is complicated, results in the increase of the cost or size, further, the position accuracy between the exposure unit and the process unit can not be maintained, further, the cleaning of the exposure unit is difficult.

Accordingly, in the present invention, the exposure unit and the process unit cab be integrally drawn out, the retreating mechanism of the exposure unit when the unit is drawn out, is made unnecessary, the structure is made simple, and the cost reduction and space reduction are realized.

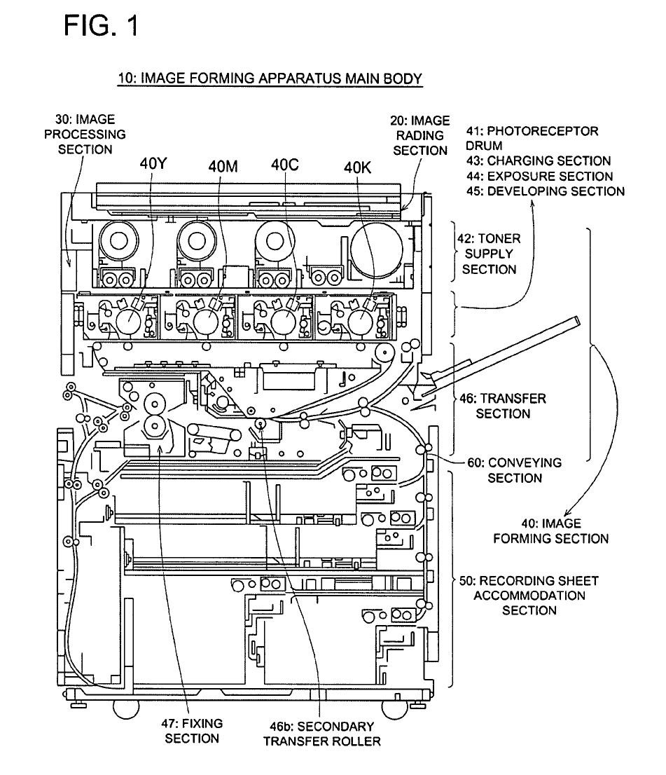

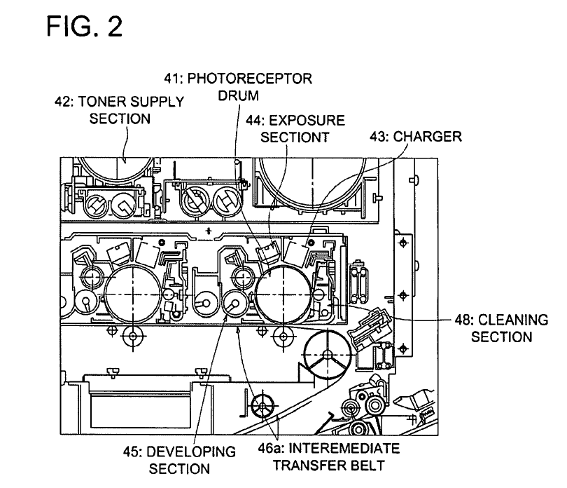

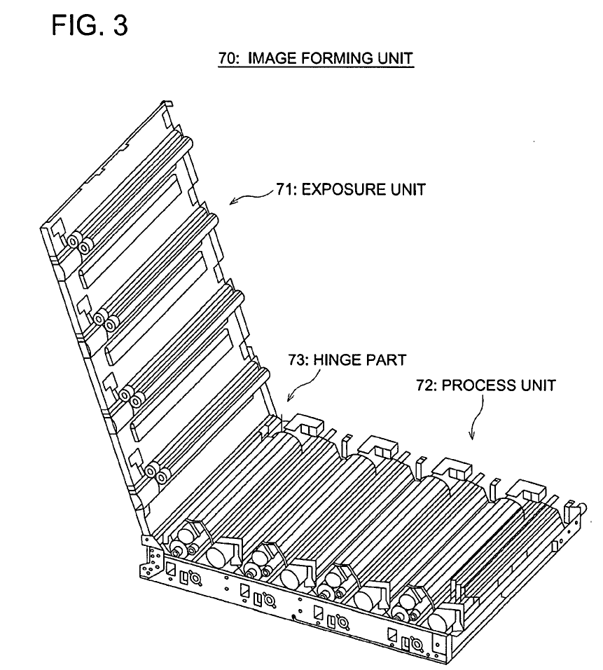

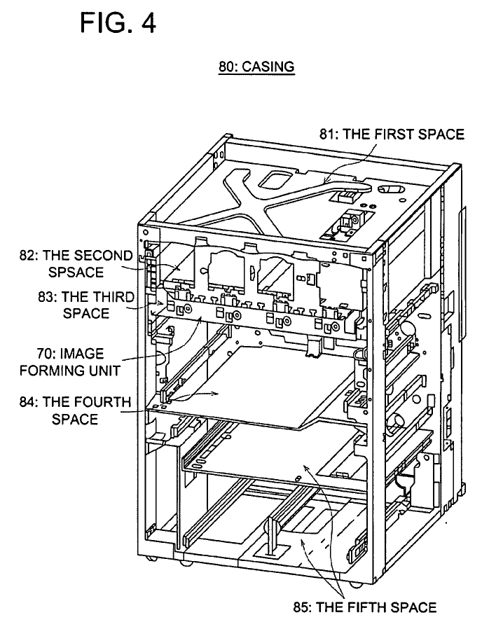

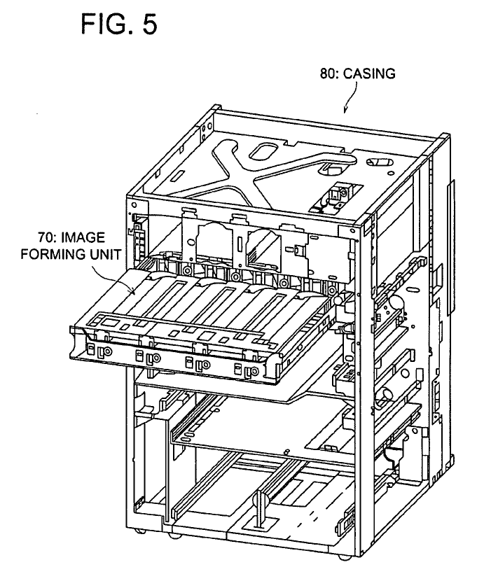

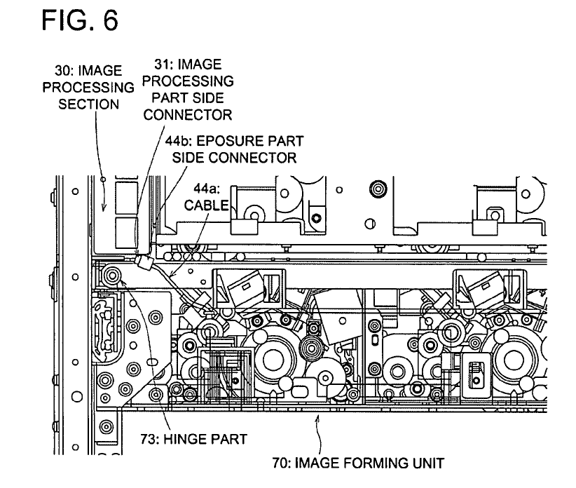

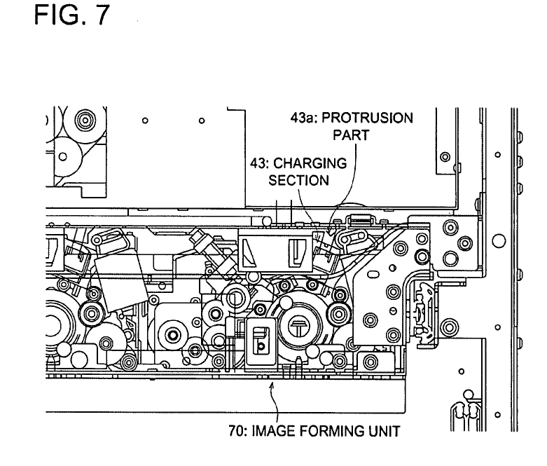

Referring to drawings 1-7, above described embodiments of the present invention will be described below. FIG. 1 is a view showing the internal structure of the image forming apparatus main body of the present embodiment, FIG. 2 is an enlarged view of a part of the image forming section. Further, FIG. 3 is a perspective view showing the structural example of the image forming unit including the exposure unit and the process unit, FIG. 4 is a perspective view showing the structure of the casing of the image forming apparatus main body. FIG. 5 is a perspective view showing a situation that the image forming unit is assembled in the casing. Further, FIG. 6 and FIG. 7 are partial sectional views of the situation that the image forming unit is loaded into the casing.

The image forming apparatus of the present embodiment is a digital system copier by which the image formation is conducted by a publicly known electronic photographing technology, as shown in FIG. 1, and is structured by the image forming apparatus main body 10 and the automatic document feeder, not shown.

Further, the image forming apparatus main body 10 is an apparatus called a tandem type color image forming apparatus, and is structured by the image reading section 20 for reading the image from the document, the image processing section 30 for processing the image read by the image reading section 20, the image forming section 40 (40Y, 40M, 40C, 40K) for forming the image for each color based on the signal from the image processing section 30, the sheet accommodation section 50 for accommodating the sheet, and the conveying section 60 for conveying the sheet from the sheet accommodation section 50 to the image forming section 40, and for delivering the recording sheet onto which the image is transferred.

The image reading section 20 is provided with the optical system for exposure scanning the document placed on the platen, and the line image sensor CCD by which the reflected light from the document is converted into the electrical signal.

The image processing section 30 is provided with a circuit substrate for conducting on the electric signal of the image reading section 20, analog processing, A/D conversion, shading correction, image compression processing, on the output end of the circuit substrate, the connector for connecting to a cable of the exposure section is provided.

Further, as shown in FIG. 1 and FIG. 2, the image forming section 40 is provided with a drum-like photoreceptor 41, the charger 43 for charging the photoreceptor 41, and the light emitting element such as LED (Light Emitting Diode) array which light emits based on the image data, and is structured by the exposure section 44 for writing the electrostatic latent image on the photoreceptor 41, the developing section 45 for developing the electrostatic latent image, the toner supply section 42 for supplying the toner to the developing section 45, the transfer section 46 provided with the primary transfer section for transferring the toner image onto the intermediate transfer belt 46a, and the secondary transfer section for secondary transferring the toner image transferred onto the intermediate transfer belt 46a, onto the sheet by the secondary transfer roller 46b, the fixing section 47 for heating and pressing the transferred toner image and fixing it, and the cleaning section 48 for cleaning the photoreceptor 41.

When the operation of the image forming apparatus main body 10 structured as above, will be described, the document placed on the platen of the automatic document feeder, not shown, is conveyed to the image reading section 20, by the optical system of the image reading section 20, the image of the document is scan-exposed, and read into the line image sensor CCD.

After, on the signal photoelectrically converted by the line image sensor CCD is, in the image processing section 30, analog processing, A/D conversion, shading correction, image compression processing are conducted, the signal is sent to the image forming section 40 through the connector.

In the image forming section 40, an electrostatic latent image is formed on the photoreceptor drum 41 charged by the charger 43 according to the image data, made into the visual image by the developing section 45, the visual image is transferred onto the intermediate transfer belt 46a supported movably, wound by a plurality of rollers.

On the one hand, in the conveying section 60, the sheet is supplied from the sheet accommodation section 50 to the secondary transfer section in timed relationship with the image formation, the sheet is nipped between the intermediate transfer belt 46a and the secondary transfer roller 46b, when the voltage of the reverse polarity to the charging polarity of toner is applied on the secondary transfer roller 46b, the toner image transferred onto the intermediate transfer belt 46a is electrostatic-transferred onto the sheet.

Then, the sheet onto which the toner image is electrostatic-transferred, is conveyed to the fixing section 47 by the conveying section 60, the heat and pressure are applied by the fixing section 47, the toner image on the sheet is fixed, and the sheet is delivered by the conveying section 60.

Herein, the image forming apparatus is, for making the maintenance and inspection easy, each section is unitized, for example, the exposure section 44 is the exposure unit, the photoreceptor 41, charging section 43, developing section 45 and the cleaning section 48 of the photoreceptor 41 are structured as the process unit. Because In the structure in which only the process unit is drawn from the image forming apparatus main body 10, the above described problem is generated, in the present embodiment, as shown in FIG. 3, the exposure unit 71 is structured by the exposure section 44 of all colors of yellow (Y), magenta (M), cyan (C), black (K), and the process unit 72 is structured by the photoreceptor 41 and charging section 43, developing section 45 of all colors, and the cleaning section 48 of the photoreceptor 41, further, the image forming unit 70 in which the exposure unit 71 and the process unit 72 are structured so that it can be opened and closed by the hinge part 73, is formed.

Then, as shown in FIG. 4, the casing 80 provided with the first space 81 for accommodating the image reading section 20, the second space 82 for accommodating the toner supply section 42, the third space 83 for accommodating the image forming unit 70, the fourth space 84 for accommodating the transfer section 46 and the fixing section 47 of the image forming section 40, and the fifth space 85 for accommodating the sheet accommodation section 50, is provided, and the image forming unit 70 is accommodated in the third space 83 so that it can be drawn out. FIG. 5 shows the situation that the image forming unit 70 is drawn from the third space 83.

As described above, in the present embodiment, because the exposure unit 71 and the process unit 72 are integrally drawn from the casing 80, it is not necessary that the mechanism for retreating the exposure unit 71 before drawn out is provided, as the result, the structure is simplified and the cost can be reduced, and insufficient space is neglected and the size can be reduced. Further, because the exposure unit 71 and the process unit 72 are interlocked by the hinge part 73 so that can be opened and closed, the position misalignment between units can be prevented, and the access to the exposure unit 71 and the process unit 72 is made easy, the maintenance and inspection can be easily conducted.

Hereupon, FIG. 3 is an example of the image forming unit 70, the exposure unit 71 and the process unit 72 may be a structure which can be opened and closed by the hinge part 73, the specific structure or the arrangement of the hinge part 73, the structure of the exposure unit 71 or the arrangement of the exposure section 44, the structure of the process unit 72, or the arrangement of the photoreceptor drum 41, charging section 43, developing section 45, cleaning section 48 is not particularly limited. For example, in the present embodiment, the process unit 72 is structured by the photoreceptor drum 41, charging section 43, and developing section 45 and the cleaning section 48, the modification that a part of the transfer section 46 is included in the process unit 72, is also possible.

Further, in FIG. 3, the hinge part 73 is provided at the side part of the left side, however, it may also provided at the side part of the opposite side of right side, or provided at both sides, and the exposure unit 71 of the left side 2 colors (for example, yellow (Y), magenta (M)) is made such that they can be opened and closed by the left side hinge part 73, and the exposure unit 71 of the right side 2 colors (for example, cyan (C), black (K)) can also be made such that they can be opened and closed by the right side hinge part 73. Further, although the open and close angle of the exposure unit 71 and the process unit 72 is arbitrary, when it can be opened to the larger angle than 90° as in the view, the access to the exposure unit 71 or the process unit 72 is made easy, further, when the lock mechanism for holding in the situation that the exposure unit 71 and the process unit 72 are opened, is provided, a problem that the exposure unit 71 is freely closed at the time of the maintenance and inspection, can be avoided.

Further, in FIG. 4, although each section is accommodated into 5 spaces, in the casing 80, it is allowable when a space for accommodating such that at least, the image forming unit 70 can be drawn out, is provided, the arrangement of the structure except of the image forming unit 70 or the arrangement structure is not particularly limited. For example, the upper section of the image forming apparatus main body 10 is made such that it can be opened and closed, the image reading section 20 or the automatic document feeder is released to above, and the toner supply section 42 is structured such that it is loaded from above, and a modification that, it is structured such that for each sheet accommodation section 50, it is accommodated in the casing 80, is also possible.

As described above, the basic structure of the image forming unit 70 of the present embodiment is described, however, the structure for making the maintenance and inspection of the image forming unit 70 easy, can also be further added.

For example, as described above, because the image data processed in the image processing section 30 is transmitted to the exposure section 44, it is necessary that the exposure section 44 and the image processing section 30 are connected by a cable. Herein, in the case of the structure that only the process unit is drawn out, although the connection structure of the exposure section 44 and the image processing section 30 is not particularly a problem, as in the present embodiment, in the case of the structure that the exposure unit 71 and the process unit 72 are integrally drawn out, when the wiring of the cable is not considered, a problem that, at the time of the drawing out of the integral unit 70, or at the time of opening and closing of the image forming unit 70, a load is burdened on the cable, or the cable is damaged, is generated.

Accordingly, in the present embodiment, the inside of the casing 80, and at the side part in the vicinity of the hinge part 73, the image processing section side connector for relaying the signal outputted from the image processing section 30 is provided, on the one hand, at the tip of the cable connected to the exposure unit 71, the exposure section side connector which engages with the image processing section side connector is provided, when the image processing section side connector and the exposure section side connector are engaged, the exposure section 44 and the image processing section 30 can be made to be connected. Specifically, as shown in FIG. 6 showing the structure of the side at which the hinge part 73 of the image forming unit 70 is arranged, it is the structure in which the image processing section side connector 31 is provided in the image processing section 30 arranged in the vicinity of the upper section of the hinge part 73, with this image processing section side connector 31, the exposure section side connector 44b provided at the tip of the cable 44a connected to each exposure section 44 is made to be engaged.

Hereby, even when it is the structure in which the exposure unit 71 and the process unit 72 are integrally drawn out, the load is not burdened on the cable connecting between the image processing section 30 and the exposure section 44 or does not damage it, further, the image processing section 30 and the exposure unit 71 fixed in the casing 80, can be easily connected or separated, the operability at the time of the maintenance and inspection can be improved.

Hereupon, the position at which the image processing section side connector 31 is arranged, may be in the vicinity of the hinge part 73 of the image forming unit 70, and its specific position is not limited to the structure of the view. Further, in FIG. 6, the image processing section 30 and the exposure unit 70 are connected by one cable 44a, however, the image processing section 30 and the exposure unit 70 may also be connected by a plurality of cables 44a and a plurality of sets of connectors. Further, in the above description, the exposure section side connector 44b is provided at the tip of the cable 44a connected to the exposure unit 71, when the image forming unit 70 is drawn out, or after drawn out, both connectors are separated, however, the structure in which the image processing section side connector 31 is fixed to the casing 80, and the exposure section side connector 44b is fixed to the image forming unit 70, when the image forming unit 70 is drawn from the casing 80, the connector is automatically separated, and when the image forming unit 70 is inserted into the casing 80, the connector is automatically connected, may also be allowable.

Further, because on the charging section 43 arranged in the process unit 72, for the purpose that it charges the photoreceptor unit 41, high voltage is applied, it is necessary to securely connect to the GND line. Therefore, in the present embodiment, as shown in FIG. 7 showing the structure of the opposite side to the hinge part 73 of the image forming unit 70, when the exposure unit 71 and the process unit 72 are oppositely fixed, the structure in which a protrusion 43a for connecting the charging section 43 to GND is brought into contact with the exposure unit 71, and pressed, is adopted. Hereby, even when it is the structure in which the process unit 72 is drawn out, the charging section 43 can be securely connected to GND, the deterioration of the image due to the poor charging of the photoreceptor drum 41 can be suppressed.

Hereupon, in the present embodiment, the image forming unit 70 is structured by all color exposure unit 71 and the process unit 72, however, in the image forming apparatus of the present invention, when the exposure unit 71 and the process unit 72 can be integrally drawn out, and the exposure unit 71 and the process unit 72 may be connected so that they are opened and closed, it is allowable. For example, it is also possible that the image forming unit may be structured for each color, or the image forming unit may also be structured for each two colors, (for example, yellow (Y) and magenta (M), cyan (C) and black (K)), 3 colors and 1 color, for example, one image forming unit is structured for yellow (Y), magenta (M) and cyan (C), and another image forming unit is singly structured for black (K).

Further, in the above embodiment, the structure in which the exposure unit 71 is arranged in the upper side, the process unit 72 is arranged in the lower side, is shown, however, it may also be allowable that the structure in which the process unit 72 is arranged in the upper side, the exposure unit 71 is arranged in the lower side, is adopted, and the process unit 72 may also be opened around the hinge part 73.

Further, in the above embodiment, the structure in which the exposure unit 71 of the image forming unit 70 drawn from the casing 80 is opened to the left side, is adopted, however, the structure in which it is opened to the right side, or to left and right, or it is opened to this side, may also be adopted.

Further, in the above embodiment, the structure in which the exposure unit 71 and the process unit 72 are connected so that they can be opened and closed by the hinge part 73, is shown, however, when the exposure unit 71 and the process unit 72 can be securely engaged, the structure in which the exposure unit 71 is detachable from the process unit 72, can also be adopted.

Further, in the above embodiment, the structure in which the image forming unit 70 is drawn out in the axial direction of the photoreceptor drum 41 (that is, drawn out in the apparatus front) is adopted, however, the structure in which the image forming unit 70 is drawn out in the moving direction of the intermediate transfer belt 46a, that is, drawn out to the apparatus side part, may also be adopted.

Further, in the above embodiment, the image forming apparatus in which the image forming section 40 is arranged in tandem in the horizontal direction, is described, however, the present invention is not limited to the above embodiment, also to the image forming apparatus in which the image forming section 40 is arranged in tandem in the perpendicular direction, can be adapted in the same manner.

The present invention can be used for arbitrary image forming apparatus in which the image forming sections of a plurality of colors are arrayed in a row.

What is claimed is:

1. An image forming apparatus including a plurality of image forming sections arranged in tandem for forming an image having a plurality of colors, the image forming apparatus comprising:
an image reading section for reading an image of a document;
an exposure unit having each color exposure section for conducting each color exposure for writing the image,
a process unit having a plurality of image forming sections for forming a toner image based on the image read by the image reading section; and
a casing for accommodating the image reading section, the exposure unit and the process unit,
wherein the exposure unit and the process unit are integrated as an image forming unit and the image forming unit is structured so that it can be drawn from the casing.

2. The image forming apparatus of claim 1, further comprising a hinge part that connects the exposure unit and the process unit so that they can be opened and closed.

3. The image forming apparatus of claim 2, wherein the exposure unit, the process unit and the hinge part are configured such that the exposure unit and the process unit can be opened to an angle larger than 90° using the hinge part as a fulcrum.

4. The image forming apparatus of claim 2, further comprising:
an image processing section for processing the image read by the image reading section; and
a connector for connecting the image processing section and the exposure section, wherein the connector is provided inside the casing and at a side at which the hinge part is provided.

5. The image forming apparatus of claim 2, wherein the plurality of image forming sections are arranged in tandem in a horizontal direction and the image forming apparatus comprises a plurality of image forming units including one or more exposure section of each color and one or more process unit of corresponding each color, each image forming unit of the plurality of image forming units is structured so that it can be drawn from the casing.

6. The image forming apparatus of claim 5, further comprising a plurality of hinge parts each connects each exposure unit and each process unit.

7. The image forming apparatus of claim 1, wherein the exposure unit includes LED (light emitting diode) print head.
